(19) United States
(12) Patent Application Publication
(10) Pub. No.: US 2025/0073561 A1
(43) Pub. Date: Mar. 6, 2025

(54) SNOWBOARD AND BRAKING SYSTEM

(71) Applicants: Charles Bruce BRADLEY, Thornton, CO (US); John Charles BRADLEY, Denver, CO (US)

(72) Inventors: Charles Bruce BRADLEY, Thornton, CO (US); John Charles BRADLEY, Denver, CO (US)

(21) Appl. No.: 18/818,544

(22) Filed: Aug. 28, 2024

Related U.S. Application Data
(60) Provisional application No. 63/579,490, filed on Aug. 29, 2023.

(51) Int. Cl. A63C 7/10; A63C 5/03; A63C 5/04; A63C 5/12; B33Y 40/00; B33Y 80/00

(52) U.S. Cl. CPC A63C 7/1066; A63C 5/03; A63C 5/0434; A63C 5/12; B33Y 40/00; B33Y 80/00; A63C 2203/18

(57) ABSTRACT

Disclosed herein are systems and methods relating to a snowboard that includes a raised edge rail and one or more pockets where the sidecut meets the nose and/or tail of the snowboard; and to a snowboard that includes a braking system. Aspects of the present disclosure relate to a snowboard that includes one or more sensors, including position sensors, distance sensors, accelerometers, or other sensors, that may detect information related to the snowboard motion and/or position. Sensor data may be utilized, in some aspects, to signal a braking system to engage under certain conditions.

### BACKGROUND

A snowboarder may desire to ride in a manner that requires additional torque, for example, to engage a rail or other feature of a terrain park. A snowboarder may desire to perform a trick similar to those performed on a skateboard. However, unlike a skateboard, a snowboard is traditionally connected to the rider via bindings that secure the rider's boots to the board, rendering some tricks (for example, those that require flipping a skateboard beneath the rider's feet) unperformable. A challenge faced by some snowboarders is that a board that is not connected to their boots or which has broken away from them may slide down the mountain. Thus, snowboards that have features designed to facilitate certain types of riding, those that may be ridden without being bound to the rider's foot, and those that have a braking system to prevent runaway may be desired.

### SUMMARY

Aspects of the present disclosure relate to a snowboard that includes a raised edge rail and one or more pockets where the sidecut meets the nose and/or tail of the snowboard. Aspects of the present disclosure further relate to a snowboard that includes a braking system. In some examples, the braking system includes a stop such as a rod or pin that engages downward to contact the ground surface beneath the snowboard (e.g. snow) to prevent the snowboard from sliding down a grade. Aspects of the present disclosure relate to a snowboard that includes one or more sensors, including position sensors, distance sensors, accelerometers, or other sensors, that may detect information related to the snowboard motion and/or position. Sensor data may be utilized, in some aspects, to signal a braking system to engage under certain conditions (e.g. when the snowboard sensor is at least a threshold distance away from an associated device on the rider). Sensor data may be utilized, in some aspects, by the rider to evaluate board performance or riding ability.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 illustrates a bottom view of a snowboard in accordance with the principles of the present disclosure, according to an example.

FIG. 2A illustrates a partial view of the snowboard of FIG. 1.

FIG. 2B illustrates a partial view of the snowboard of FIG. 1.

FIG. 3 illustrates a side view of a snowboard including one or more sensors, in accordance with the principles of the present disclosure, according to an example.

FIG. 4A illustrates a partial side view of the snowboard of FIG. 3, including a braking apparatus in a disengaged position.

FIG. 4B illustrates a partial side view of the snowboard of FIG. 3, including a braking apparatus in an engaged position.

FIG. 5A illustrates a schematic of a snowboard of FIG. 3 and a user, including a sensor pair.

FIG. 5B illustrates a schematic of a snowboard of FIG. 3 and a user, including a sensor pair, with the snowboard outside of a threshold sensor range.

FIG. 5B illustrates a partial side view of the snowboard of FIG. 3, including a braking apparatus in an engaged position.

FIG. 6 illustrates a method for engaging a snowboard braking apparatus in accordance with the principles of the present disclosure, according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. The following detailed description is therefore not to be taken in a limiting sense, and the scope of the present disclosure is defined by the appended claims and their equivalents.

A snowboarder may desire to ride in a manner that requires additional torque, for example, to engage a rail or other feature of a terrain park. Aspects of the present disclosure relate to a snowboard that includes a raised edge rail and one or more pockets where the sidecut meets the nose and/or tail of the snowboard. Such features may allow the rider to utilize the torsional flexion of the snowboard to engage the snowboard's edge(s). Such features may also allow for varied, untraditional manipulation of the board so that tricks not typically associated with snowboard riding may be performed. In some examples, a shape of the pockets extends from the base of the board, partially through the board, stopping short of the top layer. A rider can utilize or leverage the pocket shape to control the board movement and tricks being performed.

A snowboarder may desire to perform a trick similar to those performed on a skateboard. However, unlike a skateboard, a snowboard is traditionally connected to the rider via bindings that secure the rider's boots to the board, rendering some tricks (for example, those that require flipping a skateboard beneath the rider's feet) unperformable. In some examples, a snowboard as disclosed herein may be intended to be ridden without bindings. In some examples, a board that is not connected to their boots or which has broken away from them may slide down the mountain. Some snowboarders choose to wear a leash that connects their snowboard to their person.

However, use of a leash may not be desired by some user and may inhibit performing certain tricks. Snowboards disclosed herein may include a braking system/apparatus. In some examples, the braking system includes a rod or pin that engages downward to contact the ground surface beneath the snowboard (e.g. snow) to prevent the snowboard from sliding down a grade.

In some examples, snowboards as disclosed herein may include one or more sensors, including position sensors, distance sensors, accelerometers, receivers, or other sensors, that may detect information related to the snowboard motion and/or position. Sensor data may be utilized, in some aspects, to signal a braking system to engage under certain conditions (e.g. when the snowboard sensor is at least a threshold distance away from an associated device on the rider). Sensor data may be utilized, in some aspects, by the rider to evaluate board performance or riding ability (for example, may be viewable on a computer, smartphone, or other device).

Although the particular examples disclosed herein are discussed in relation to a snowboard, disclosed features may be applicable to other types of boards and equipment, such as snow skis, snowskates, splitboards, powder surfboards, water skis, wakeboards, surf boards, wakesurf boards, skateboards, kiteboards, or others.

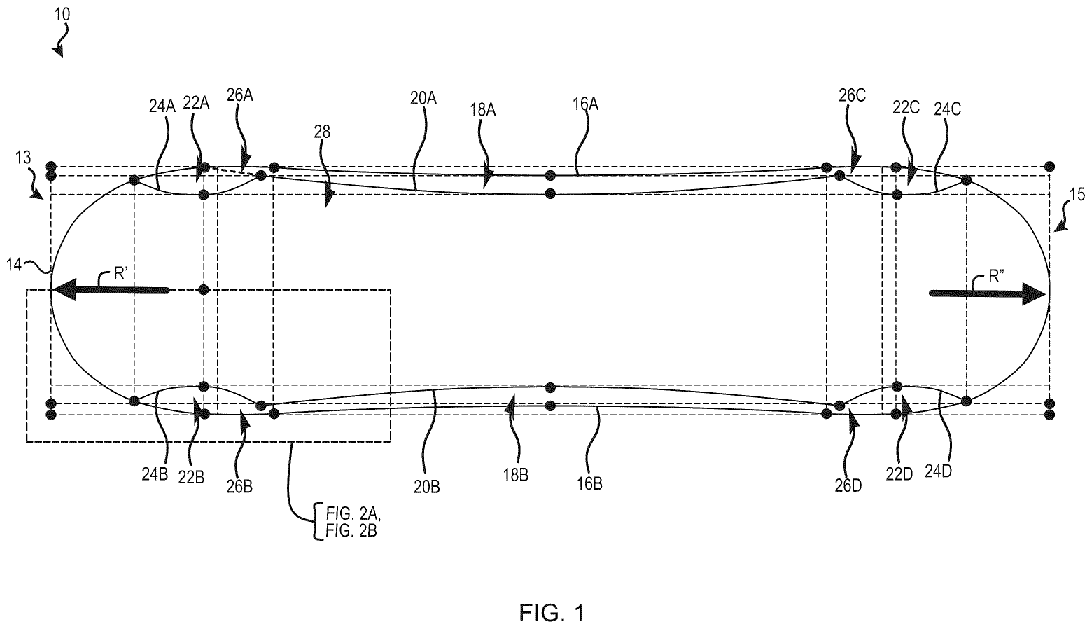

These and other examples will be explained in more detail below with respect to FIG. 1-FIG. 6.

FIG. 1 illustrates a bottom view of a snowboard 10. In some examples, snowboard 10 has a bottom surface 28 configured to contact and slide along a ground surface and/or park features (which is opposite an upper surface 12, configured to be ridden by a rider (snowboarder)). Snowboard 10 is bounded by an outer perimeter 14, which includes sidecuts 16A, 16B on either long edge. Snowboard 10 includes a nose end 13 and a tail end 15, which are opposite each other. In some examples, nose end 13 and tail end 15 include identical or similar features and shapes (for example, on a board that is designed to be ridden switch). In some examples, nose end 13 and tail end 15 include different features and shapes (for example, on a directional board).

Along one or both sidecuts 16A, 16B, snowboard 10 may include a raised edge rail 18. Raised edge rail 18 may extend along all of or a portion of sidecuts 16A, 16B, and has a width defined between each sidecut sidecuts 16A, 16B and a defining curve 20A, 20B. Raised edge rail 18 may have a maximum width along a center of sidecuts 16A, 16B with lesser widths along the ends of sidecuts 16A, 16B toward the nose end 13 and tail end 15. In some examples, the width of the raised edge rail 18 may be consistent along sidecuts 16A, 16B.

In some examples, snowboard 10 includes one or more pockets 22A, 22B, 22C, 22D. Pockets 22A, 22B, 22B, 22C are bounded by a part of outer perimeter 14 (near the ends of sidecuts 16A, 16B toward the nose end 13 and tail end 15) and a pocket curve 24A, 24B, 24C, 24D. In some examples, snowboard 10 includes pockets 22A, 22B, 22C, 22D at both the nose end 13 and tail end 15 of the snowboard. In some examples, snowboard 10 includes pockets 22A, 22B, 22C, 22D that are identical. In some examples, snowboard 10 includes pockets 22A, 22B at nose end 13 that are different from pockets 22C, 22D at the tail end 15. In some examples, snowboard 10 includes two pockets 22. In some examples, snowboard 10 includes 4 pockets. In some examples, snowboard 10 includes pockets 22 that are identical. In some examples, snowboard 10 includes pockets 22 that have different features. In some examples, one or all of pockets 22A, 22B, 22C, 22D may be egg-shaped, oval-shaped, J-shaped, elliptically-shaped, or another suitable shape. The pockets 22A, 22B, 22C, 22D may be concave. In some examples, pockets 22A, 22B, 22C, 22D and/or raised edge rails 18A, 18B are located on a bottom surface 28 of the snowboard 10. In some examples, pockets 22A, 22B, 22C, 22D and/or raised edge rails 18A, 18B are located on both an upper surface 12 of the snowboard 10 and a bottom surface 12 of the snowboard 10.

In some examples, the raised edge rails 18A, 18B and pockets 22A, 22B, 22C, 22D do not overlap. In some examples, the raised edge rail 18 and pockets 22A, 22B, 22C, 22D overlap at a pocket-rise intersection 26A, 26B, 26C, 26D. Raised edge rail 18 and/or pockets 22A, 22B, 22C, 22D raise the affected portions of bottom surface 28 above the flat plane of the ground surface when the snowboard 10 is positioned at a plane parallel to and flat against the ground surface. The presence of and characteristics of raised edge rails 18A, 18B and pockets 22A, 22B, 22C, 22D affect the performance and abilities of the snowboard 10 (for example, a raised edge rail may allow a rider to leverage torsional flexion of the board to engage the rail, but too high of an edge rail may decrease the amount of control a rider feels).

In some examples, nose end 13 and/or tail end 15 may be characterized by a radius R′, R″. In some examples, the radius R′, R″ of the nose end 13 and the tail end 15 is equal. In some examples, the radius R′ of the nose end 13 is not equal to the radius R″ of the radius of the tail end 15. In some examples, pockets 22A, 22B, 22C, 22D are positioned fully in front of, fully behind, partially in front of, centrally aligned with, or in another orientation in relation to the location of the radius of the nose end 13 and/or tail end 15 on either side edge of the nose end 13 and/or tail end 15, respectively.

In some examples, snowboard 10 may be of a length within the ranges of a typical snowboard, skateboard, surfboard, or other board. In some samples, snowboard 10 may be of a width within the ranges of a typical snowboard, skateboard, surfboard, or other board. The length and/or width of snowboard 10 may be determined by the type of riding the snowboard 10 is intended for (for example, riding on groomed runs vs. backcountry powder runs). In some examples, snowboard 10 is configured for a snowboarder to ride with bindings (for example, may have features on upper surface 12 such as holes for installation of bindings). In some examples, snowboard 10 is configured for a snowboarder to ride without bindings, and may include features such as grip portions for a rider's feet/shoes/boots.

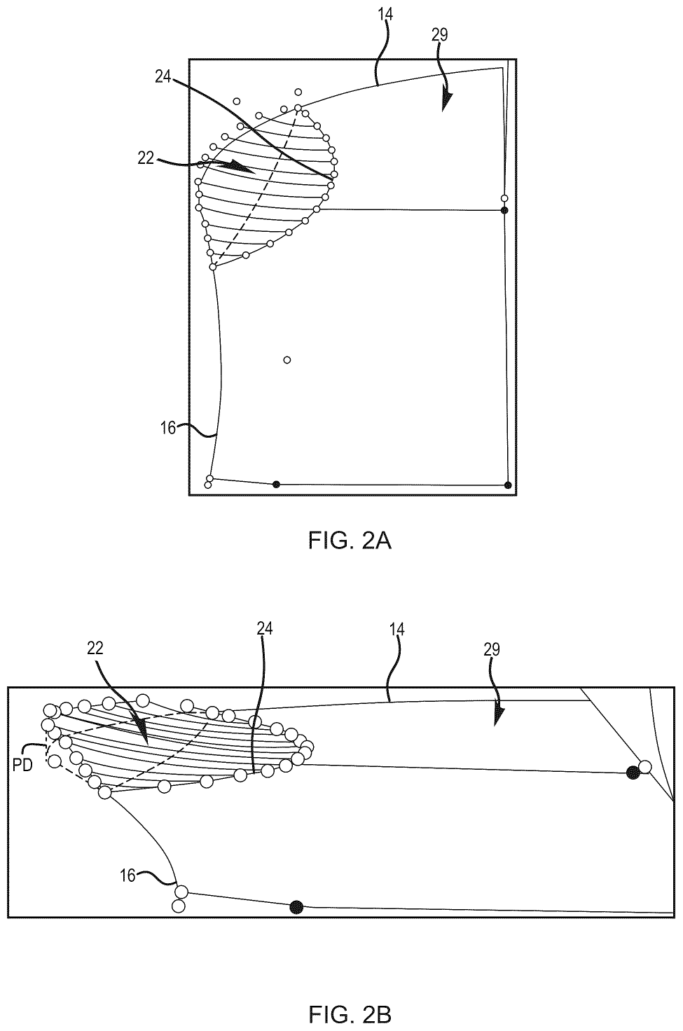

FIGS. 2A and 2B illustrate a partial view of snowboard 10. FIGS. 2A and 2B are described concurrently and not all components described are visible in both FIG. 2A and FIG. 2B. In some examples, pocket 22 includes a maximum pocket depth PD along a portion of the outer perimeter 14. Pocket 22 may slope or curve down to pocket curve 24 at bottom surface 28. FIGS. 2A and 2B illustrate this pocket depth PD from the perspective of a partial top view of a base layer, where a core-facing surface 29 of the bottom surface 28 is visible in FIGS. 2A and 2B.

In some examples, the maximum PD may be about 2 cm. In some examples, the maximum PD may be less than about 2 cm. In some examples, the maximum PD may be greater than about 2 cm. In some examples, the maximum PD may be about 2.5 cm. In some examples, the maximum PD may be less than about 2.5 cm. In some examples, the maximum PD may be greater than about 2.5 cm. In some examples, the maximum PD may be between about 2 cm and about 2.5 cm. In some examples, the maximum PD may be between about 1 cm and about 3 cm. In some examples, the maximum PD may be between about 0.5 cm and about 2.5 cm. In some examples, the maximum PD may be between about 0.1 cm and about 1.5 cm.

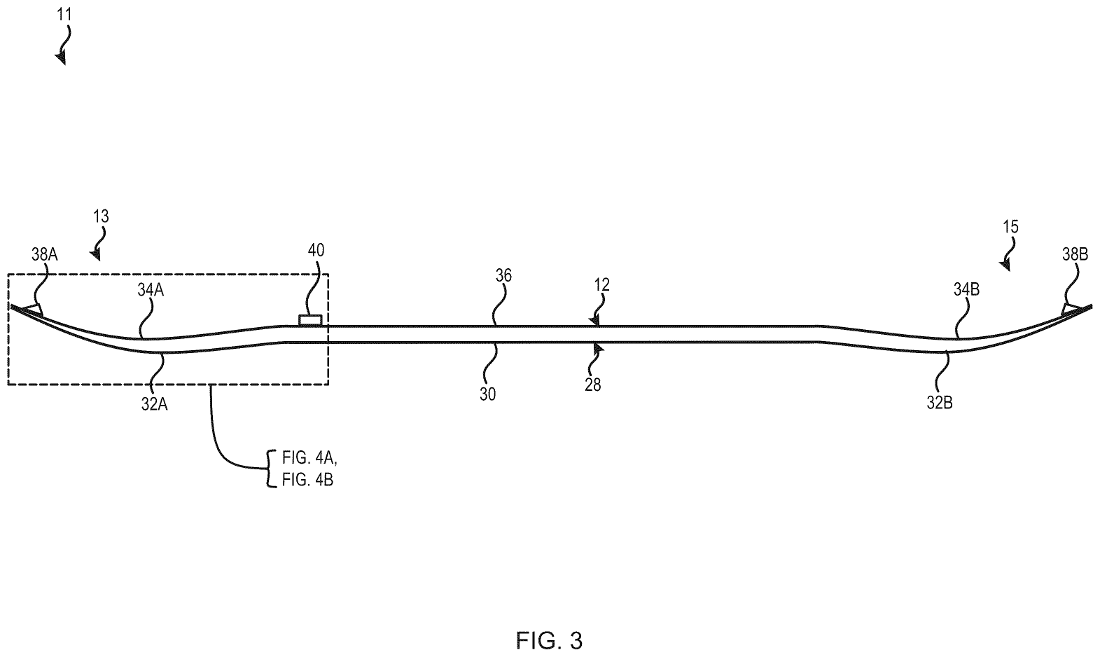

FIG. 3 illustrates a side view of a snowboard 11 that includes one or more sensors. In some examples, snowboard 11 includes features as described above with regards to snowboard 10. Snowboard 11 has an upper surface 12, which includes deck 36. In some examples, deck 36 may have features (e.g. holes) adapted for installation of bindings. In some examples, deck 36 may be configured for a rider to ride snowboard 11 without bindings, and may include features such as grip portions for a rider's feet/shoes/boots. Upper surface 12 is opposite bottom surface 28, which includes a base 30. Bottom surface 28 is configured to ride along a ground surface (e.g. snow). In some examples, the side profile of snowboard 11 may include various cambers, rockers, and/or flat portions. In the example shown, snowboard 11 includes a cambered base 30 and rockers 32A, 32B (which correspond to low points 34A, 34B of the upper surface 12), however, other profiles and camber types may be contemplated. Nose end 13 and/or tail end 15 rise above the plane of the ground surface.

In some examples, snowboard 11 includes one or more sensors 38A, 38B. Sensors 38A, 38B may include proximity sensors, accelerometers, receivers, or other types of sensors. Sensors 38A, 38B may be installed at one or more locations along any portion of snowboard 11. Sensors 38A, 38B may be installed within the materials of construction of snowboard 11, along the side of snowboard 11, or along upper surface 12. In an example, sensor data (e.g. accelerometer data) may be reviewed by a rider during or after a ride so that they may evaluate performance of the snowboard or aspects of their riding skill. An accelerometer may measure information such as pitch, yaw, rotation, speed, or other data points.

In an example sensor 38A, 38B may include a beacon. For example, if a snowboard slides or is lost in a place where the rider cannot locate it (e.g. under a snowbank or in deep powder), the beacon may send or receive a signal that allows a rider or other user to locate it (for example, the signal may be sent to a smartphone, smart watch, computer, transceiver, or other device). In some examples, the beacon on the snowboard actively transmits a signal that is received by another device. In some examples, the beacon on the snowboard includes a passive transponder that may be detected by a detector device (for example, a radar system). In some examples, a receiver may receive a beacon signal on a detected/not detected basis. In some examples, a receiver may receive a beacon signal that is of a varying signal strength, and the strength of the signal may indicate a proximity or distance to the beacon.

In an example, sensor 38A, 38B may include a proximity sensor. In an example, the proximity sensor may monitor a proximity of a rider/user to an associated unit (for example, a receiver on the snowboard) or second sensor associated with a rider. In an example, the proximity sensor may monitor a proximity of the snowboard to an associated unit (for example, a receiver carried by a user/rider) or second sensor associated with a rider. In some examples, the proximity sensor(s) send or receive signals of a particular strength, and that strength is higher when the snowboard sensor is nearer the user sensor; as the distance between the snowboard sensor and user sensor increases, the signal strength decreases. In some examples, the strength of the signal is correlated to a discreet distance or a distance range. If the proximity sensor detects that the snowboard is at least or greater than a predetermined threshold distance away from the associated unit (or has that the signal strength has dropped below a predetermined threshold), a signal may be sent to instruct an action be taken. An action may include activating a braking system, notifying a rider, or other relevant action.

Sensors 38A, 38B may be powered by at least one power source 40. Power source 40 may include rechargeable batteries (for example, by a type of USB or other suitable recharging means), replaceable batteries (for example, disc batteries, AAA, AA, or other suitable replaceable batteries), another suitable power source, or combinations thereof. In some examples, snowboard 11 may include a housing or adaptation to enclose one or more extra batteries. Snowboard 11 may include one or more power sources 40, and each power source 40 may be redundant, may be stand-alone, may supply power to one power user, or may provide power to multiple power users. Power source 40 may be installed within the materials of construction of snowboard 11, along the side of snowboard 11, or along upper surface 12. Snowboard 11 may include a switching device for switching from one power source 40 to another.

Sensors 38A, 38B may be connected to power source 40 via wires/cables/fibers on the surface of the snowboard 11. Sensors 38A, 38B may be connected to power source 40 via wires/cables/fibers routed through the materials of the snowboard 11. In some examples, sensors 38A, 38B and/or power source 40 with each other and/or with other systems via wired (for example, a wiring harness)/cabled/fibered means. In some examples, sensors 38A, 38B and/or power source 40 with each other and/or with other systems via wireless means. As used herein, wireless communication means may include Bluetooth, wi-fi, radio communications, cellular network communications, electromagnetic communications, GPS communications, or other applicable wireless communication methods.

In some examples, sensors 38A, 38B and/or power source 40 may be included within one or more common or shared modules. In some examples, sensors 38A, 38B and/or power source 40 may be included as separate modules. In a particular example, sensor 38A and power source 40 may be included in a shared module. In a particular example, sensor 38B and power source 40 may be included in a shared module. In some examples, modules may be removed from the snowboard 11 (for example, by removing fasteners such as screws, or by unattaching via removal from a detent or other twist or snap-type connection mechanism). Easy/convenient removal of the modules may provide for easy maintenance, installation of new or different modules, or installation of the removed module onto a second board (for example, another snowboard or a board of a different type).

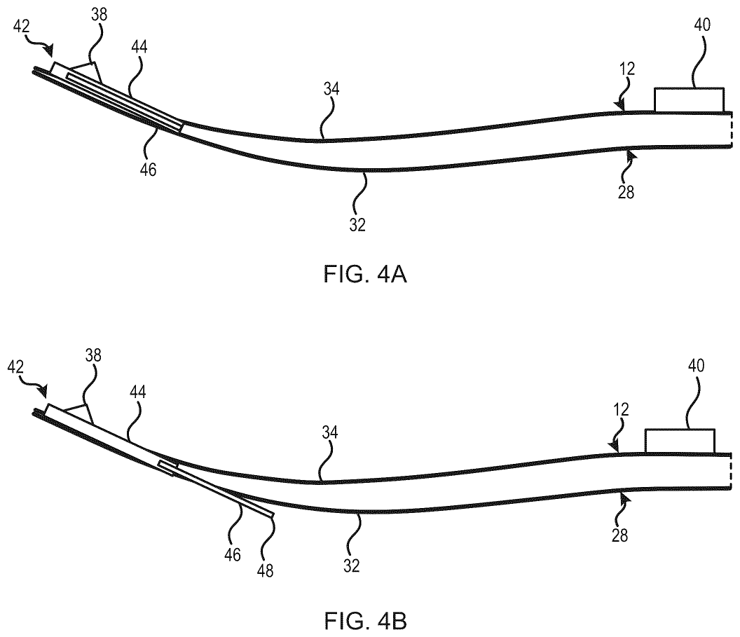

FIG. 4A illustrates a partial side view of snowboard 11, including a braking apparatus in a disengaged position. FIG. 4B illustrates a partial side view of snowboard 11, including the braking apparatus in an engaged position. FIGS. 4A and 4B are described concurrently and not all components described are visible in both FIG. 4A and FIG. 4B. In some examples, snowboard 11 includes one or more braking systems. Although the example shown depicts a braking apparatus 42 that includes a stop (for example, a rod, pin, spike, or other) 46 and an associated housing 44, other types of braking system may be contemplated. In an example, braking may be initiated based on sensor data. In an example, the braking apparatus 42 is connected to power source 40. In an example, the braking apparatus 42 includes a separate power source. In an example, the braking apparatus 42 is driven by a biasing element, such as a spring. In some examples, braking apparatus 42 communicates with one or more sensors 38A, 38B and/or with other systems via wired/cabled/fibered means. In some examples, braking apparatus 42 communicates with one or more sensors 38A, 38B and/or with other systems via wireless means. In some examples, braking apparatus 42 includes one or more deployment devices that, when activated, engage the braking apparatus 42. In some examples, the deployment devices may include solenoids, linear actuators, or other suitable devices.

In the example shown, braking apparatus 42 includes a housing 44 that at least partially encloses a stop 46. In other examples, braking apparatus 42 may include a stop 46 such as a pin, rod, hook, spike, or other stop 46 type. Housing 44 may be installed/mounted to a side of snowboard 11. Stop 46 may be circular, square, or another shape in diameter. When the braking apparatus 42 may include a driving force for stop 46, for example, a spring. In some examples, when the braking apparatus 42 disengaged (see FIG. 4A), the stop 46 is retracted within housing 44 and does not contact a ground surface, thus allowing the bottom surface 28 to slide along the ground surface (for example, allowing the snowboard 11 to slide/be ridden on snow down a hill or along park features). In some examples, when the braking apparatus 42 is engaged (see FIG. 4B), the stop 46 is extended so that it protrudes out of the housing 44. An end or tip 48 of the stop 46 contacts the ground surface, and the resulting friction/engagement slows or stops the snowboard from sliding along the ground surface. In some examples, the braking apparatus 42 is engaged automatically. In some examples the braking apparatus 42 may be automatically or manually reset (disengaged) after engagement, so that the stop 46 is retracted back within the housing 44. In some examples, disengagement is triggered by sensing that the snowboard 11 has been placed (for example, picked up by its rider or another user) into a vertical position. In some examples, disengagement is triggered by a distance/proximity of the snowboarder to the snowboard 10, 11 being at or below a predetermined threshold distance. In some examples, the failure position of the braking apparatus 42 is such that the brake apparatus 42 is engaged if power or signal are lost.

In some examples, snowboards 10 and 11 as described above may comprise one or more materials. Snowboards 10, 11 may include one or several layers of materials. For example, a snowboard 10, 11 may include layers such as a topsheet, a core, a base, and may include other layers in between those layers. The base may be waxed. Snowboards 10, 11 may include a metal edge (for example, a steel edge) at least along the sidecut 16. In some examples, materials may include fiberglass, plastic or other polymers (which may be 3D printed, extruded, sintered, or otherwise constructed and which may include polyurethane), wood (for example, beech, poplar, birch, bamboo, or others), metal (for example, steel, aluminum, or others), glass, enamels, nylon, other materials, composites, or combinations thereof. In some examples, materials may include one or more stringers. Different materials of construction and combinations of materials may be selected to as to influence desired characteristics of the snowboards 10, 11, such as flexibility, strength, torsion, weight, and other properties.

In some examples, snowboards 10, 11 may be constructed via methods utilizing pressing, 3D printing, cutting, sculpting, production on a CNC machine, other production/manufacture/assembly methods, or combinations thereof. Channels, housings, and other features for enclosing, attaching, or connecting to power source 40, sensors 38, braking apparatus 42, and associated wires/cables/fibers/other equipment may be formed into the surface, sides, and/or layers of snowboards 10, 11. In some examples, components maybe located within one or more layers of snowboards 10, 11, and the one or more layers may be configured to have a replaceable and/or removable layer, so that contained components may be maintained, removed, or replaced.

In some examples, a method of constructing a board 10, 11 may include: 3D printing a first layer of a snowboard and attaching a second layer of a snowboard to the first layer. In some examples, the second layer may also have been 3D printed (for example. In some examples, the first layer includes a feature for attaching one or more wires. In some examples, the first layer includes one or more pockets and at least one raised edge rail on a bottom surface of the first layer. In some examples, a component of the snowboard may be 3D printed, for example, including features, parts of (or for interacting with) the braking apparatus 42, sensors 38, equipment, and others. The 3D printed component (for example, a part of the braking apparatus 42) may be attached to at least one of the first layer and the second layer of the snowboard.

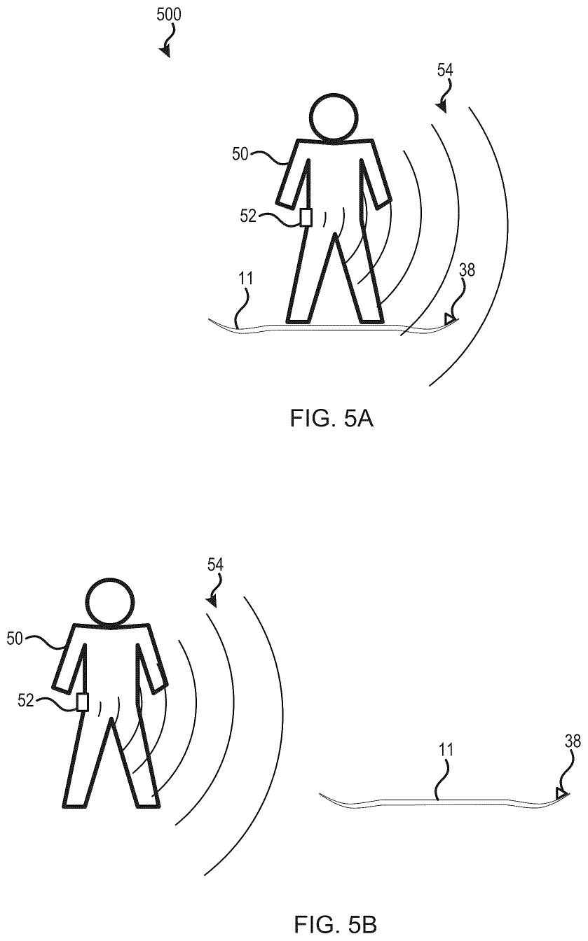

FIG. 5A illustrates a schematic of a snowboard of FIG. 3 and a user, including a sensor pair. FIG. 5B illustrates a schematic of a snowboard of FIG. 3 and a user, including a sensor pair, with the snowboard outside of a threshold sensor range. FIGS. 5A and 5B are described concurrently and not all components described may be visible in both FIG. 5A and FIG. 5B.

As described above, snowboard 11 may include at least one sensor 38, which may include a proximity sensor. Snowboard 11 may be ridden by a user/rider 50. User 50 may carry a sensor device 52. In the particular example shown, sensor device 52 may (continuously or intermittently) send a signal 54. In some examples, the strength of the signal 54 weakens further away from sensor device 52. The signal 54 may be received at sensor 38 of snowboard 11. The strength of signal 54 received at sensor 38 may be above a certain threshold when the snowboard 11 is within a threshold distance from the user 50 (for example, when the user 50 is riding the snowboard 11, performing a trick with the snowboard 11, or carrying snowboard 11). See, for example, FIG. 5A.

If the strength of signal 54 received at sensor 38 is below a certain threshold, it may be determined that the snowboard 11 is greater than a threshold distance from the user 50 (for example, when the snowboard 11 is sliding away from or has slid away from user 50, or when snowboard 11 is lost in a snowbank). See, for example, FIG. 5B. If the strength of signal 54 received at sensor 38 is below the certain threshold (i.e. the snowboard 11 is greater than a threshold distance from the user 50), actions such as those described above and below may be taken, such as activating a brake or sending a notification.

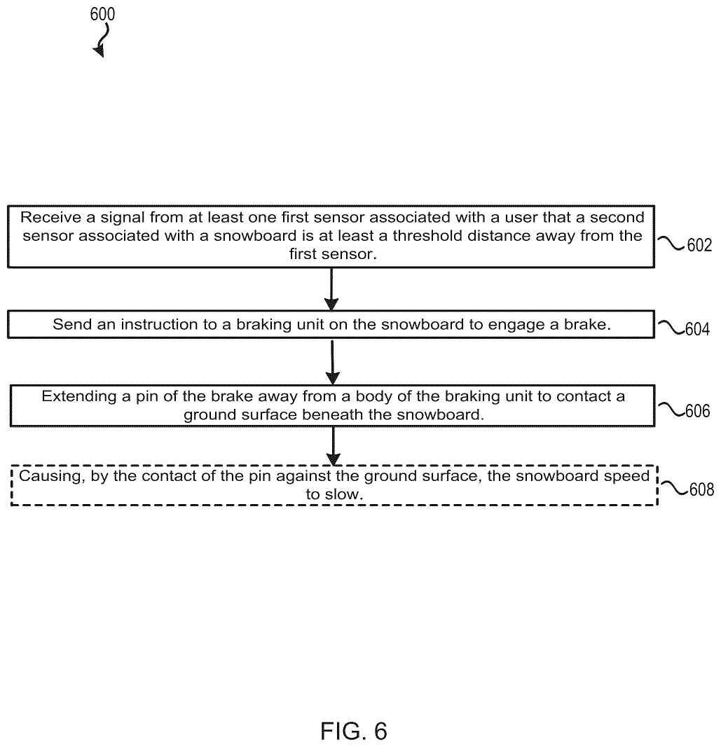

FIG. 6 illustrates a method 600 for engaging a snowboard braking apparatus. At operation 602, a signal is received from at least one first sensor associated with a user/rider that a second sensor associated with a snowboard is at least a threshold distance away from the first sensor (for example, more than 6 feet away, more than 10 feet away, or other predetermined distances). For example, a proximity sensor carried by a user/rider may signal that a receiver or another proximity sensor on a snowboard is more than a certain number of feet away from the user/rider. This situation may occur, in some examples, if a snowboarder is riding a board without bindings, and the board begins to slide down a hill after the snowboarder loses physical contact with the snowboard.

At operation 604, an instruction is sent to a braking unit/apparatus on the snowboard to engage a brake (for example, a braking apparatus such as braking apparatus 42).

At operation 606, a stop (for example, stop 46, which may include a pin) of the brake is extended away from a body (for example, housing 44) of the braking unit to contact a ground surface beneath the snowboard (for example, snow).

At operation 608, the contact of the stop against the ground surface causes the snowboard speed to slow and potentially for the snowboard to stop.

In accordance with principles of this disclosure, materials of construction for the systems and components as described herein include materials that are compatible with the environment, cleaning and sanitizing considerations, and use and performance of the systems and components.

For the purposes of this application, the depicted axes, along with terms such as “upper,” “lower,” “front,” “rear,” “upward,” “downward” “frontward,” and “rearward” are intended to be descriptive with reference to and in relation to the orientation shown in the Figures for clarity, but the examples as practiced and included in the scope of the claims may include examples where the systems and devices are in a different orientation.

While particular uses of the technology have been illustrated and discussed above, the disclosed technology can be used with a variety of environments in accordance with many examples of the technology. The above discussion is not meant to suggest that the disclosed technology is only suitable for implementation within the environments shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art. As should be appreciated, the various aspects described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process or method are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or operations are disclosed only as illustrative aspects. The scope of the technology is defined by the following claims and any equivalents therein.

What is claimed is:

1. A method of engaging a braking apparatus, comprising:
receiving a signal from at least one first sensor associated with a user that a second sensor associated with a snowboard is at least a threshold distance away from the first sensor;
sending an instruction to a braking apparatus on the snowboard to engage a brake, the brake comprising a housing and a stop, the stop being housed at least partially within the housing when the braking apparatus is disengaged; and
in response to receiving the instruction, extending the stop away from the housing to contact a ground surface beneath the snowboard.

2. The method of claim 1, further comprising:
causing, by the contact of the stop against the ground surface, a speed of the snowboard to slow.

3. The method of claim 1, wherein the stop comprises a pin, the pin being housed at least partially within the housing when the braking apparatus is disengaged

4. The method of claim 1, wherein the first sensor is a proximity sensor.

5. A board comprising:
a bottom surface configured to slide along a ground surface;
an upper surface configured for a user to ride;
an outer perimeter;
a pair of side cuts that extend between a nose end of the board and a tail end of the board;
a pair of raised edge rails, each of the pair of raised edge rails being defined between one of the pair of side cuts and a defining curve; and
at least two pockets, each of the at least two pockets being defined between a portion of the outer perimeter and a pocket curve, wherein each of the at least two pockets has a first pocket height at the portion of the outer perimeter that is greater than a second pocket height at the pocket curve, wherein the at least two pockets are present on the bottom surface.

6. The board of claim 5, wherein one of the at least two pockets intersects with one of the pair of raised edge rails.

7. The board of claim 5, including at least one component manufactured by 3D printing.

8. A method of constructing a board, the method including:
3D printing a first layer of a snowboard;
attaching a second layer of a snowboard to the first layer.

9. The method of claim 8, wherein the first layer includes a feature for attaching one or more wires.

10. The method of claim 8, wherein the first layer includes one or more pockets and at least one raised edge rail on a bottom surface of the first layer.

11. The method of claim 8, further comprising:
3D printing a component of the snowboard; and
attaching the component to at least one of the first layer and the second layer of the snowboard.

12. The method of claim 11, wherein the component comprises a part of a braking apparatus.

13. The method of claim 8, further comprising:
prior to attaching the second layer to the first layer, 3D printing the second layer.
